(19) United States
(12) Patent Application Publication
(10) Pub. No.: US 2012/0154475 A1
(43) Pub. Date: Jun. 21, 2012

(54) PRINTING APPARATUS AND TEMPERATURE DETECTION METHOD

(75) Inventor: Hiroshi Uemura, Zushi-shi (JP)

(73) Assignee: CANON KABUSHIKI KAISHA, Tokyo (JP)

(21) Appl. No.: 13/309,044

(22) Filed: Dec. 1, 2011

(30) Foreign Application Priority Data
Dec. 21, 2010 (JP) 2010-285169

(51) Int. Cl. B41J 29/38

(52) U.S. Cl. 347/17

(57) ABSTRACT

This invention relates to precisely obtaining a head temperature free from influence of a signal transferred to a printhead, without slowing down the printing speed. In a printing apparatus which includes a printhead including a plurality of printing elements and a temperature sensor, and divides the plurality of printing elements into a plurality of blocks to print while performing division driving of the plurality of printing elements for each block, the head temperature is detected as follows. First, one printing period determined by a printhead driving frequency is divided into an active period required for the division driving and an inactive period required for A/D-converting an analog temperature data signal from the temperature sensor. While a signal required to drive the printhead is transferred in the active period, a digital signal A/D-converted from the temperature data signal from the printhead is read in the inactive period.

### BACKGROUND OF THE INVENTION

1. Field of the Invention

The present invention relates to a printing apparatus and a temperature detection method. Particularly, the present invention relates to a temperature detection method of detecting the temperature in an inkjet printhead while scanning the printhead in a printing apparatus which mounts the printhead.

2. Description of the Related Art

These days, a printing apparatus typified by a printer is prevalent, and is required to attain high-speed printing, high-resolution printing, and low-noise operation as a general trend. An inkjet printing apparatus is widely prevailing as an inexpensive product which meets these requirements. In the inkjet method, ink droplets are discharged from the orifice of a printhead so that they adhere to a printing medium such as paper, thereby printing. Hence, the inkjet method can not only relatively easily attain, for example, high-speed printing, but also relatively stably print an image on the printing medium with little ink nonuniformity because printing is performed while the printhead and the printing medium do not contact with each other.

The arrangement of an inkjet printhead (to be simply referred to as a printhead hereinafter) and a method of driving it will be described herein with reference to FIGS. 9 and 10.

FIG. 9 is a block diagram showing the arrangement of the peripheral portion of a driving control circuit for a printhead including 256 nozzles. Referring to FIG. 9, reference numerals 406a, 406b, 406c, and 406d denote some of 256 heaters corresponding to the 256 nozzles; and 405a, 405b, 405c, and 405d, transistors which drive the heaters 406a to 406d, respectively. Also, reference numeral 401 denotes a shift register which receives a printing data signal in accordance with a transfer clock; and 402, a latch circuit which latches, at a predetermined timing, the printing data signal received by the shift register 401. Moreover, reference numeral 403 denotes a decode circuit which generates a driving block enable signal; and 404a, 404b, 404c, and 404d, AND circuits which calculate the logical product of the printing data signal, the block enable signal, and a heat pulse signal.

FIG. 10 is a timing chart showing various signals associated with transfer of a printing data signal to the printhead. FIG. 10 illustrates an example in which the 256 nozzles (that is, the 256 heaters) are driven upon uniformly dividing them into groups of 16 nozzles (that is, groups of 16 heaters).

Therefore, a data signal having a total of 20 bits including a printing data signal having 16 bits d0 to d15 corresponding to 16 nozzles, and a signal having 4 bits BLE0 to BLE3 indicating the driving block numbers is transferred from the printing apparatus main body to the printhead for each block. Transfer data H_DATA is transferred using the two edges of a pulse signal having a transfer clock H_CLK, and a latch signal H_LAT of the transfer data is sent. A heat enable signal H_ENB for driving each heater is also sent.

In this case, nozzle columns are assumed to be driven in the order of driving blocks “0” to “15”, for the sake of descriptive convenience. Therefore, first, transfer data H_DATA are serially transferred in synchronism with a transfer clock H_CLK, and sequentially held in the shift register 401 in the printhead. Next, the transfer data H_DATA are latched by the latch circuit 402 in accordance with a data latch signal H_LAT. Of the latched, 20-bit transfer data signal, 4 bits are decoded by the decode circuit 403 to generate a block enable signal, so a predetermined block enable signal, printing data signal, and heat enable signal are input to each AND gate. Only when these three signals input to each AND circuit are all valid, a transistor corresponding to this AND circuit is turned on to drive a corresponding heater, thereby discharging ink.

At the timing at which driving block “0” is actually driven, data is transferred to driving block “1”. This operation is repeated to drive 256 heaters corresponding to 16 driving blocks. Then, ink is continuously discharged with respect to the direction in which the printhead is scanned, thereby forming an image in the scanning region.

In a printhead which discharges ink using a heater, the ink discharge amount is known to change with a change in head temperature and, more specifically, ink temperature. When the ink discharge amount changes, dots having different diameters are formed by ink droplets adhering on the printing medium, resulting in a density difference albeit very small. In the case of serial printing, this density difference occurs from the printing start position in the direction in which the printhead is scanned to the printing end position in this direction, as shown in FIGS. 11A to 11D. This appears as printing density unevenness, leading to degradation in image quality.

When, for example, a set of printing data have the same value, ideally no density difference occurs from the printing start position to the printing end position, as shown in FIG. 11A. In other words, in this case, the ink discharge amount remains the same over the range from the printing start position to the printing end position, as shown in FIG. 11B. However, in an actual printhead, with progress in printing, the head temperature rises, as shown in FIG. 11C, so the ink discharge amount changes, as shown in FIG. 11D.

Hence, to suppress such a change in ink discharge amount due to a rise in head temperature, Japanese Patent Laid-Open No. 5-31905, for example, proposes an approach of applying a double-pulse to the printhead in one ink discharge operation and controlling, for example, the pulse width of the pre-pulse (performing its preheat control). This pulse control is based on the head temperature, so the temperature in the printhead is obtained by employing an arrangement, as shown in FIG. 12, for data exchange between the printing apparatus and the printhead.

In the arrangement shown in FIG. 12, a printing apparatus main body 301 and a printhead 302 are connected to each other via a flexible cable. The printing apparatus main body 301 includes a CPU 303 and can read a value output from an A/D converter 306. A head control circuit 304 controls the printhead 302 and generates a control signal for driving the printhead 302. The printing apparatus main body 301 also includes an amplifier 305 which amplifies an analog output signal from a head temperature sensor 310, and an analog value output from the head temperature sensor 310 is input to the A/D converter 306 and converted into a digital value. The printhead 302 includes a head driving control circuit 307 which generates a heater driving signal in accordance with the control signal sent from the head control circuit 304, and a head driving circuit 308 which actually drives a heater 309. Note that the heater 309 corresponds to the heaters 406a to 406d shown in FIG. 9. Note also that the printhead 302 includes the head temperature sensor 310 which detects the temperature in the printhead 302, and outputs an analog signal.

In such an arrangement, to print with higher image quality, pulse control for driving the printhead is desirably performed in real time in response to a change in head temperature as much as possible. However, when the printhead 302 and the printing apparatus main body 301 are connected to each other via a flexible cable, the signal output from the head temperature sensor 310 suffers from crosstalk due to, for example, a data transfer clock, a transfer data signal, a latch signal, and a heat enable signal. As a result, induced noise is mixed with the signal output from the head temperature sensor 310, thus making it difficult to obtain a precise head temperature during printing scanning of the printhead.

To solve this problem, a method as disclosed in Japanese Patent Laid-Open No. 2002-264305, for example, has conventionally been proposed. That is, a sample-hold signal is provided to each of a plurality of printheads mounted in a printing apparatus to discriminate based on the sample-hold signal whether or not a driving pulse is applied to each printhead, upon detecting the temperature in the printhead. By outputting temperature measurement data to the printing apparatus main body at the timing at which a driving pulse is applied to none of the printheads, the temperature is obtained free of the influence of crosstalk resulting from a control signal.

Since the above-mentioned prior art method obtains the temperature at the timing at which a driving pulse is applied to none of the plurality of printheads, the temperature can actually be obtained at three timings shown in FIGS. 13A to 13C. FIG. 13A shows the timing when both printheads A and B are placed at positions that fall outside the printing region. In this case, it is difficult to obtain the temperature during actual printing. FIG. 13B shows the timing when printing corresponding to 16 blocks is ended in one column period, and the temperature is obtained using the extra time until the discharge timing of the next column. In this case, as the printing speed decreases, the time period corresponding to the distance between consecutive columns prolongs, so it is possible to obtain the temperature during printing. However, as the printing speed increases, the time period from the end of printing of 16 blocks until the discharge timing of the next column shortens, so it becomes more difficult to ensure the time taken to obtain the temperature. FIG. 13C shows that the timing when the temperature is obtained in the period in which no control signal is output in one block that is obtained by equally dividing one column period. In this case, it is necessary to set a relatively long period for one block, so it becomes more difficult to obtain the temperature as the printing speed increases, as in the case of FIG. 13B.

### SUMMARY OF THE INVENTION

Accordingly, the present invention is conceived as a response to the above-described disadvantages of the conventional art.

For example, a printing apparatus and a temperature detection method according to this invention are capable of precisely obtaining the temperature in a printhead free of the influence of a signal transferred to the printhead, without slowing down the printing speed.

According to one aspect of the present invention, there is provided a printing apparatus comprising: a printhead including a plurality of printing elements and a temperature sensor; a driving unit configured to divide the plurality of printing elements into a plurality of blocks to print on a printing medium and perform division driving of the plurality of printing elements for each block; an A/D converter configured to A/D-convert an analog temperature data signal output from the temperature sensor; a division unit configured to divide one printing period of the printhead, which is determined by a driving frequency of the printhead, into an active period required for the division driving, and an inactive period required for A/D conversion by the A/D converter; a transfer unit configured to transfer a signal required to drive the printhead to the printhead in the active period; and a reading unit configured to read a digital signal obtained by A/D-converting, by the A/D converter, the temperature data signal output from the printhead in the inactive period.

According to another aspect of the present invention, there is provided a temperature detection method for a printing apparatus which includes a printhead including a plurality of printing elements and a temperature sensor, and divides the plurality of printing elements into a plurality of blocks to print on a printing medium while performing division driving of the plurality of printing elements for each block, comprising: dividing one printing period of the printhead, which is determined by a driving frequency of the printhead, into an active period required for the division driving and an inactive period required for an A/D converter to A/D-convert an analog temperature data signal output from the temperature sensor; transferring a signal required to drive the printhead to the printhead in the active period; and reading a digital signal obtained by A/D-converting, by the A/D converter, the temperature data signal output from the printhead in the inactive period.

The invention is particularly advantageous since one printing period is divided into an active period in which a driving signal of a printhead is transferred and an inactive period in which no driving signal of the printhead is transferred, and a head temperature signal is obtained in the inactive period, thus making it possible to precisely obtain the head temperature free of the influence of crosstalk resulting from the driving signal. The invention is also advantageous since the active period and the inactive period are specified from the driving frequency of the printhead, thereby obtaining the temperature in the printhead with neither an influence on the printing speed nor a slowdown in printing speed.

Further features of the present invention will become apparent from the following description of exemplary embodiments with reference to the attached drawings.

### BRIEF DESCRIPTION OF THE DRAWINGS

FIG. 1A is a perspective view showing the schematic arrangement of a serial inkjet printing apparatus according to an exemplary embodiment of the present invention.

FIG. 1B is a view for explaining an arrangement of nozzles and driving blocks of a printhead.

FIG. 2 is a block diagram showing the control arrangement of the printing apparatus shown in FIG. 1A.

FIG. 3 is a block diagram showing an arrangement for obtaining the head temperature in the printing apparatus shown in FIG. 1A.

FIG. 4 is a view showing the state in which one column period is divided into 18 blocks in consideration of an inactive period corresponding to two blocks, compared to 16 driving blocks.

FIG. 5 is a view illustrating block division and the driving block number of each nozzle column when registration adjustment is performed for each nozzle column.

FIG. 6 is a timing chart of signals associated with a first method of obtaining the head temperature in an inactive period.

FIG. 7 is a timing chart of signals associated with a second method of obtaining the head temperature in an inactive period.

FIG. 8 is a timing chart of signals associated with a method, which combines the first and second methods, of obtaining the head temperature in an inactive period.

FIG. 9 is a block diagram showing the arrangement of the peripheral portion of a driving control circuit for a printhead including 256 nozzles.

FIG. 10 is a timing chart showing various signals associated with transfer of a printing data signal to the printhead.

FIGS. 11A to 11D are graphs for explaining the occurrence of a density difference from the printing start position in the direction in which the printhead is scanned to the printing end position in this direction.

FIG. 12 is a block diagram showing the printing apparatus main body and printhead connected to each other.

FIGS. 13A to 13C are timing charts showing the timings at which the head temperature can be obtained in the conventional printing apparatus.

FIG. 14A is a sectional view of a full-line inkjet printing apparatus according to another embodiment.

FIG. 14B is a view for explaining an arrangement of nozzles and driving blocks of a full-line printhead.

### DESCRIPTION OF THE EMBODIMENT

An exemplary embodiment of the present invention will now be described in detail in accordance with the accompanying drawings.

In this specification, the terms “print” and “printing” not only include the formation of significant information such as characters and graphics, but also broadly include the formation of images, figures, patterns, and the like on a print medium, or the processing of the medium, regardless of whether they are significant or insignificant and whether they are so visualized as to be visually perceivable by humans.

Also, the term “print medium” not only includes a paper sheet used in common printing apparatuses, but also broadly includes materials, such as cloth, a plastic film, a metal plate, glass, ceramics, wood, and leather, capable of accepting ink.

Furthermore, the term “ink” (to be also referred to as a “liquid” hereinafter) should be extensively interpreted similar to the definition of “print” described above. That is, “ink” includes a liquid which, when applied onto a print medium, can form images, figures, patterns, and the like, can process the print medium, and can process ink. The process of ink includes, for example, solidifying or insolubilizing a coloring agent contained in ink applied to the print medium.

Furthermore, the term “printing element” is a generic term used to refer to an element which produces energy for an orifice, a liquid channel which communicates with it, and ink discharge.

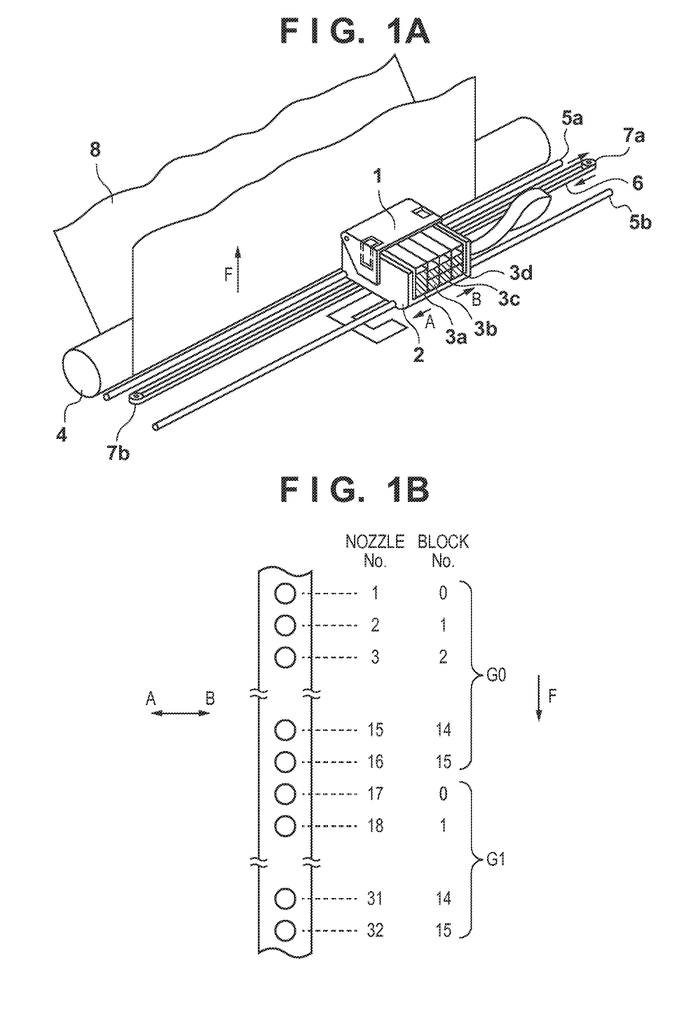

FIG. 1A is a schematic perspective view of a serial inkjet printing apparatus (to be simply referred to as a printing apparatus hereinafter) capable of color printing according to an exemplary embodiment of the present invention.

As shown in FIG. 1B, an inkjet printhead (to be simply referred to as a printhead hereinafter) 1 includes a plurality of nozzle columns, and discharges ink droplets onto a printing medium 8 to form dots on it, thereby printing an image on it. The printhead 1 is mounted on a carriage 2.

Also, in the printing apparatus, four ink cartridges 3a, 3b, 3c, and 3d which store magenta (M), cyan (C), yellow (Y), and black (K) inks, respectively, are mounted on the carriage 2, as shown in FIG. 1A. The ink cartridges 3a, 3b, 3c, and 3d can be attached/detached independently. The carriage 2 is attached to a belt 6 looped around pulleys 7a and 7b. Note that one of the two pulleys 7a and 7b is connected to a carriage motor (not shown), and the carriage 2 reciprocally moves in directions indicated by arrows A and B along guide shafts 5a and 5b by the driving force of the carriage motor.

At the time of printing, a printing medium 12 such as a printing paper sheet is fed via a paper feed mechanism (not shown), it is conveyed to the printing position by a conveyance roller 4, and ink is discharged from the printhead 1 onto the printing medium 8 at this printing position, thereby printing. Reference symbol F denotes the direction in which the printing medium 8 is conveyed. A plurality of nozzles are provided, as shown in FIG. 1B. In this case, it is assumed that the printhead 1 includes 32 nozzles, for the sake of easy explanation. The 32 nozzles are divided into two groups G0 and G1, and the nozzles in each group are assigned to 16 blocks and time-divisionally driven. The 32 nozzles are driven for each block.

Note that the printhead 1 adopts the inkjet method of discharging ink utilizing thermal energy. Hence, the printhead 1 includes electrothermal transducers (heaters). This electrothermal transducer is provided in correspondence of each orifice, and a pulse voltage is applied to a corresponding electrothermal transducer in accordance with a printing signal, thereby heating and discharging ink from a corresponding orifice.

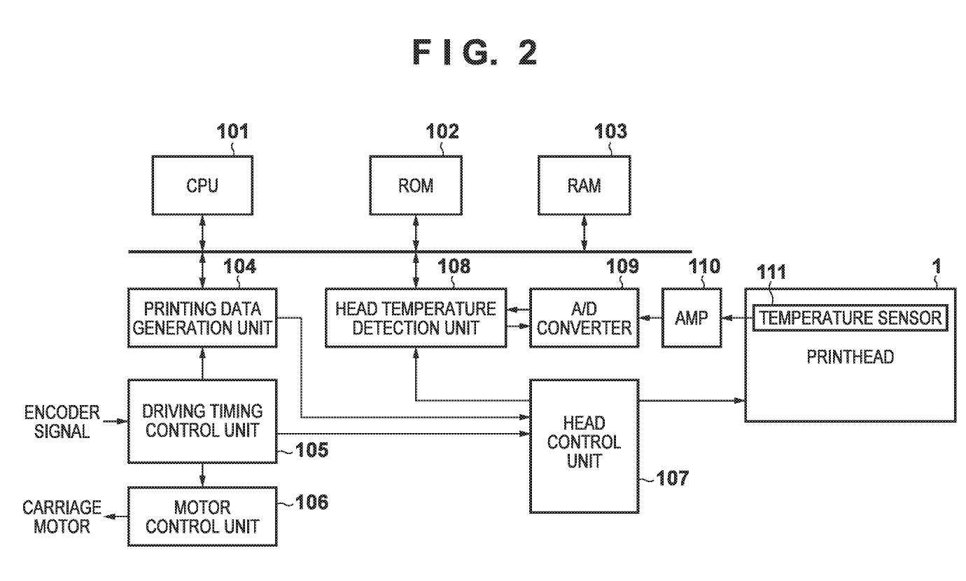

FIG. 2 is a block diagram showing the control arrangement of the printing apparatus shown in FIG. 1A.

Referring to FIG. 2, reference numeral 101 denotes a CPU; 102, a ROM which stores, for example, a program executed by the CPU 101, and other table data; and 103, a RAM used as an image buffer for storing image data and the working area of, for example, a buffer of the CPU 101. Reference numeral 104 denotes a printing data generation unit which generates actual printing data from data on the image buffer in the RAM 103. The printing data generated by the printing data generation unit 104 is transferred to the printhead 1 via a data transfer circuit in a head control unit 107 (to be described later).

Reference numeral 105 denotes a driving timing control unit which performs position and speed control in the direction in which the printhead 1 is scanned, timing control for generating printing data, and timing control for driving the printhead 1, based on an externally input encoder signal. Reference numeral 106 denotes a motor control unit which drives the carriage motor that scans the carriage 2 mounting the printhead 1, based on a timing signal generated by the driving timing control unit 105. Reference numeral 107 denotes a head control unit which performs, for example, transfer control of printing data transferred to the printhead 1, distributed drive control and heat pulse control for head driving, and temperature acquisition timing control.

Reference numeral 108 denotes a head temperature detection unit which obtains an output from an A/D converter 109 at a predetermined timing based on a timing signal input from the head control unit 107. The temperature in the printhead 1 is obtained by amplifying, by an amplifier (AMP) 110, an analog output from a temperature sensor 111 in the printhead 1, inputting the amplified analog signal to the A/D converter 109, and reading, by the CPU 101, the value of a digital signal obtained by A/D conversion.

In this embodiment, one column period is equally divided by the sum of the number of driving blocks and the number of blocks corresponding to the time required to obtain the temperature, thereby defining an active period in which a head control signal is driven, and an inactive period in which no head control signal is driven. In the inactive period, a head temperature acquisition timing is generated to obtain the head temperature.

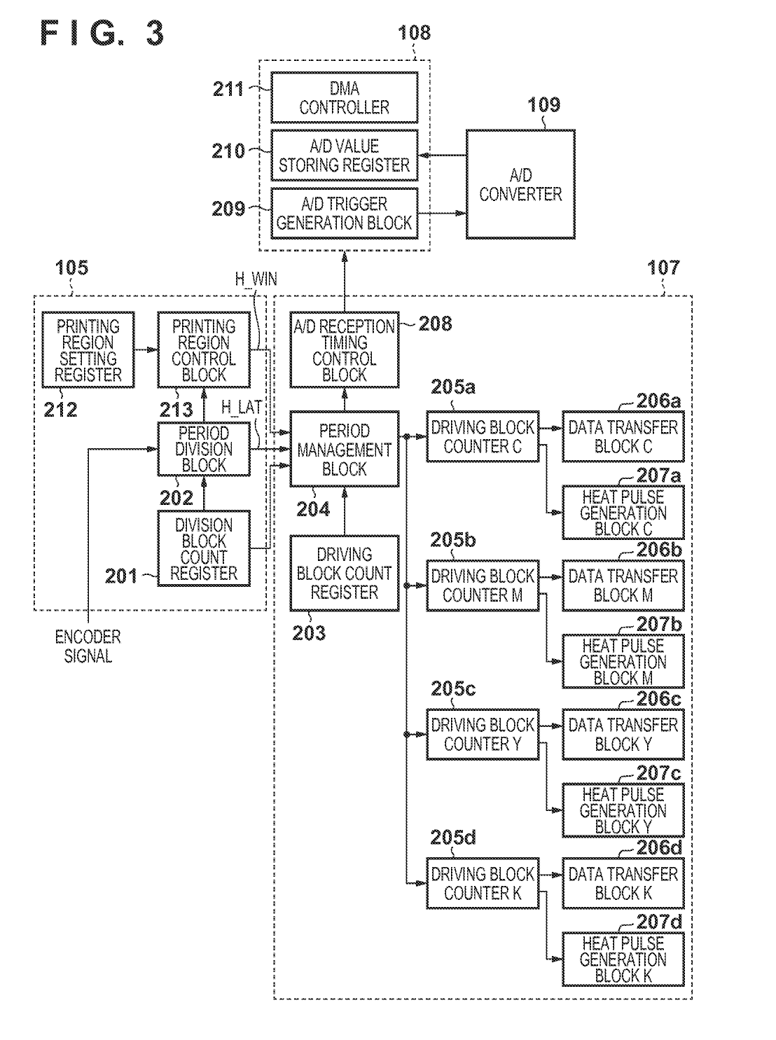

FIG. 3 is a block diagram showing an arrangement for obtaining the head temperature in the printing apparatus shown in FIG. 1A. Note that the same reference numerals as in FIG. 2 denote the same constituent elements in FIG. 3, and a description thereof will not be given.

Referring to FIG. 3, reference numeral 201 denotes a division block count register which sets the number of blocks into which one column period is divided. Reference numeral 202 denotes a period division block which refers to the division block count register 201 so as to divide one column period and thereby generate a synchronization signal H_LAT of the block period, based on an encoder signal. Reference numeral 212 denotes a printing region setting register which sets the printing start position and printing end position, in the direction in which the printhead 1 is scanned, for each nozzle column. Reference numeral 213 denotes a printing region control block which generates a printing enable signal H_WIN for each nozzle column in accordance with the setting of the printing region setting register 212, and the signal from the period division block 202. The signal H_WIN is asserted in the period in which the nozzle column of interest is scanned within the printing region.

Reference numeral 203 denotes a driving block count register serving as a setting resister which sets the number of blocks used to drive one column. The value set in the driving block count register 203 is uniquely determined by the printhead 1. Reference numeral 204 denotes a period management block which generates one column period using a specific number of division blocks by referring to the driving block count register 203, based on the signals H_WIN and H_LAT input from the driving timing control unit 105, and the setting of the division block count register 201. The period management block 204 manages one column period by dividing it into the period in which the printhead 1 is driven (the number of driving blocks), and the period in which the printhead 1 is not driven (the number of blocks obtained by subtracting the number of driving blocks from the number of division blocks). Reference numerals 205a to 205d denote driving block counters which manage the active period and the inactive period for each nozzle column; and 206a to 206d, data transfer blocks which control transfer of printing data for each nozzle column based on the information provided by the driving block counters 205a to 205d, respectively.

Reference numeral 207a to 207d denote heat pulse generation blocks which control heat enable signals for each nozzle column based on the information provided by the driving block counters 205a to 205d, respectively. Reference numeral 208 denotes an A/D reception timing control block which performs timing control for controlling temperature acquisition in the inactive period based on the information provided by the period management block 204. Reference numeral 209 denotes an A/D trigger generation block which generates a trigger signal for triggering the A/D converter 109 to perform A/D conversion, and that for DMA-transferring data from the A/D converter 109, based on a timing signal from the A/D reception timing control block 208. Reference numeral 210 denotes an A/D value storing register which stores data received from the A/D converter 109. Reference numeral 211 denotes a DMA controller which DMA-transfers temperature data stored in the A/D value storing register 210 to the temperature acquisition data storage area of the RAM 103 using a signal input from the A/D trigger generation block 209 as a trigger.

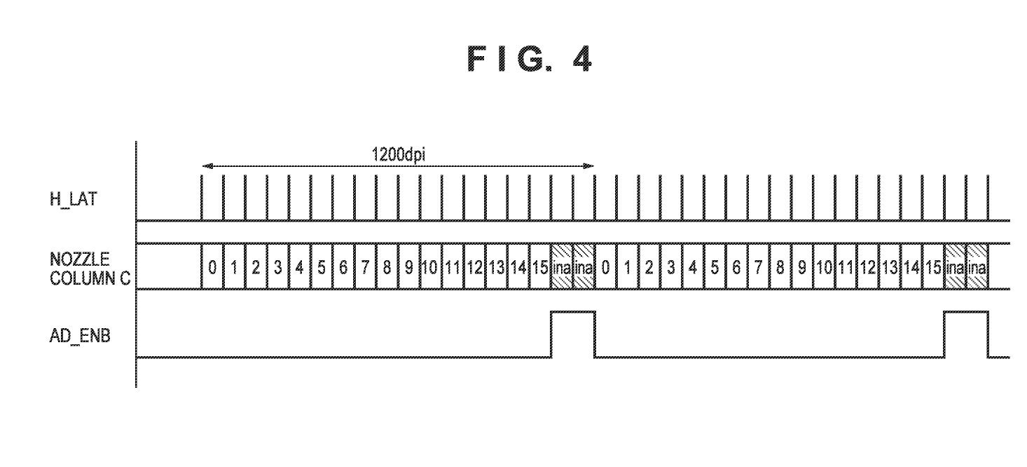

FIG. 4 is a view showing the state in which one column period is divided into 18 blocks in consideration of an inactive period corresponding to two blocks, compared to 16 driving blocks. Note that a signal AD_ENB indicates the inactive period. When, for example, the printhead 1 is driven at a driving frequency of 24 kHz for 16-division driving, one column period (one printing period) is about 41.7 μsec, so the inactive period is about 41.7/18×2=5.2 μsec.

This inactive period is sufficient to allow the A/D converter 109 to perform A/D conversion. However, if the driving frequency of the printhead 1 changes, the number of blocks to be assigned to the inactive period must change as well, so the number of divisions and the number of blocks to be assigned to the inactive period are set in the register to make them variable.

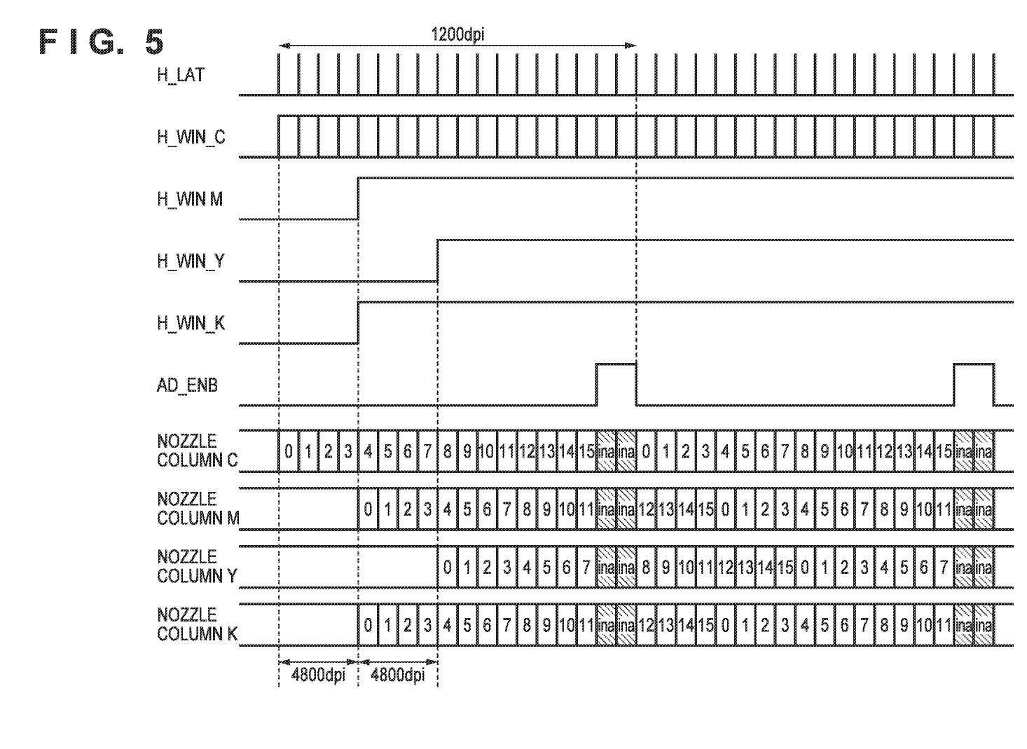

FIG. 5 is a view illustrating block division and the driving block number of each nozzle column when registration adjustment is performed for each nozzle column. In an example shown in FIG. 5, when the print resolution in the scanning direction is 1,200 dpi, nozzle column M has a registration adjustment resolution of 4,800 dpi, nozzle column Y has a registration adjustment resolution of 2,400 dpi, and nozzle column K does not require adjustment, with reference to nozzle column C. Thus, in this embodiment, each nozzle column is driven for each block so that inactive periods in each column are overlapped with each other (periods “ina” in FIG. 5).

In this embodiment, “18” is set in the division block count register 201, and “16” is set in the driving block count register 203. The period division block 202 obtains one column period from an input encoder signal, and equally divides this column period into 18 blocks to generate a signal H_LAT, in accordance with the setting of the division block count register 201. The period management block 204 divides one column period having 18 blocks into an active period corresponding to 16 blocks and an inactive period corresponding to two (2) blocks with reference to nozzle column C based on the signals H_WIN and H_LAT for each nozzle column, and manages it. Note that this management is not limited to the above-mentioned values, and a modification in which 18 blocks are divided into an active period corresponding to 17 blocks and an inactive period corresponding to one block may also be adopted.

At this time, a signal AD_ENB is asserted in the inactive period. Since no head control signal is driven in the period in which the signal AD_ENB is asserted, head temperature data can be detected free of the influence of noise. The values obtained by the driving block counters 205a to 205d in each nozzle column are incremented in the period in which a corresponding signal H_WIN is asserted, but are not updated in the period in which the signal AD_ENB is asserted because the latter period is an inactive period. The data transfer blocks 206a to 206d and heat pulse generation blocks 207a to 207d transfer neither data nor a driving control signal to the printhead 1 in the inactive period in which the signal AD_ENB is asserted.

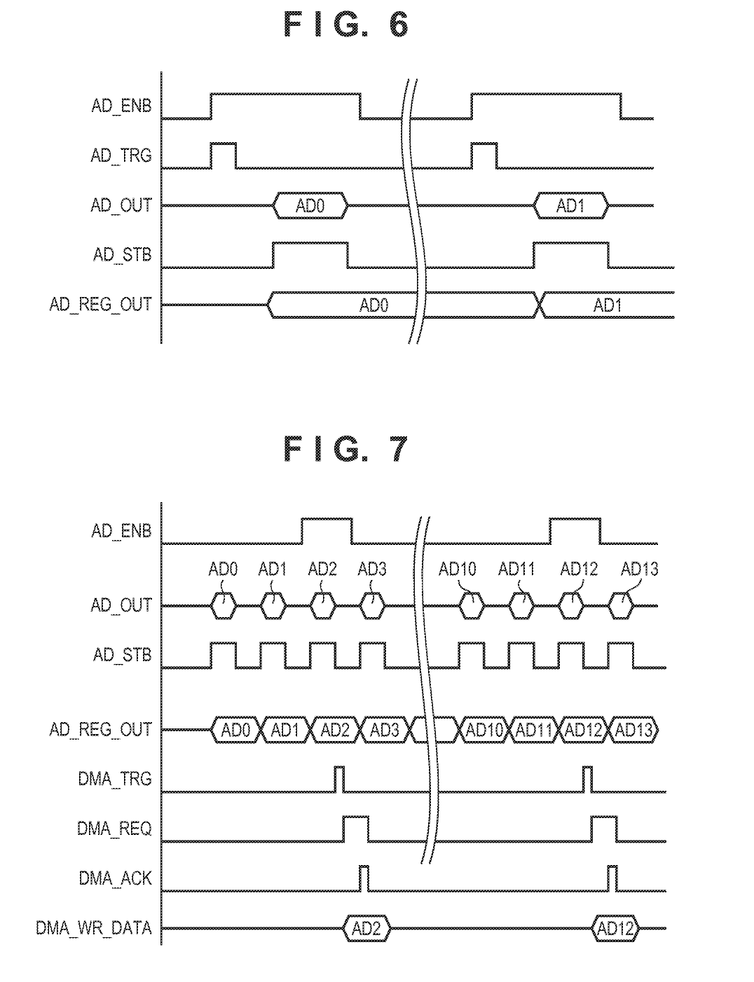

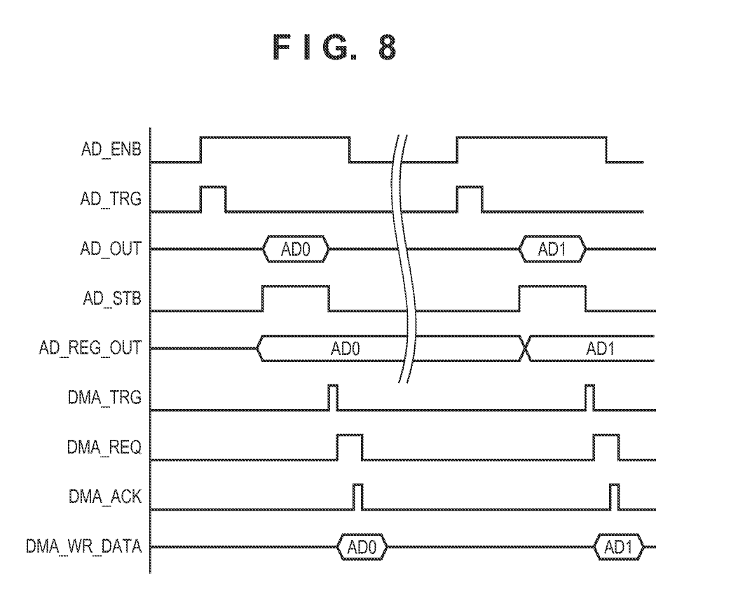

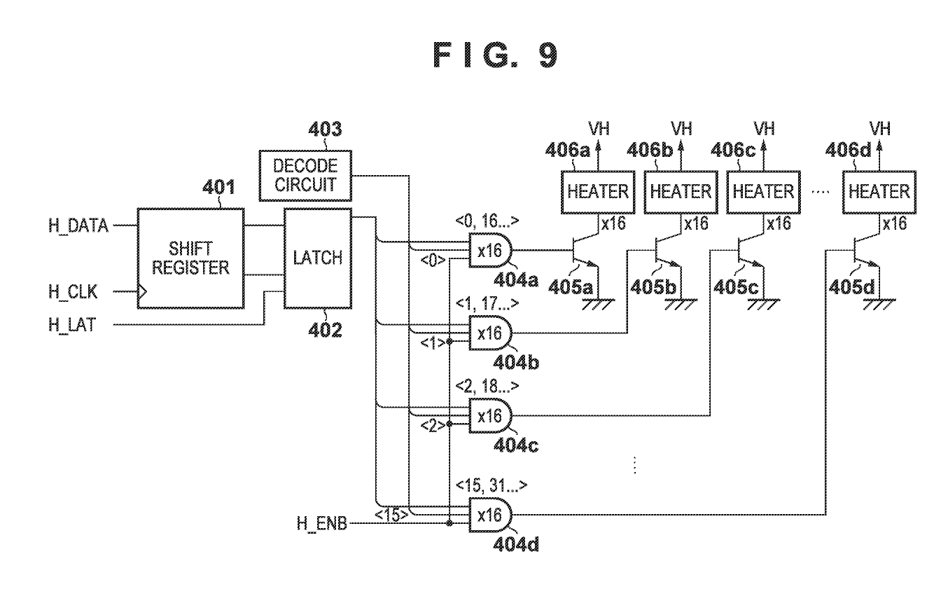

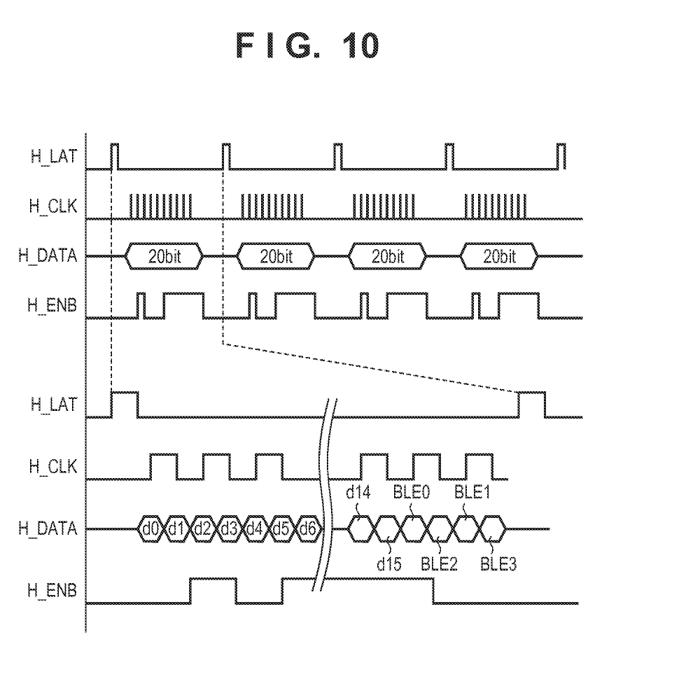

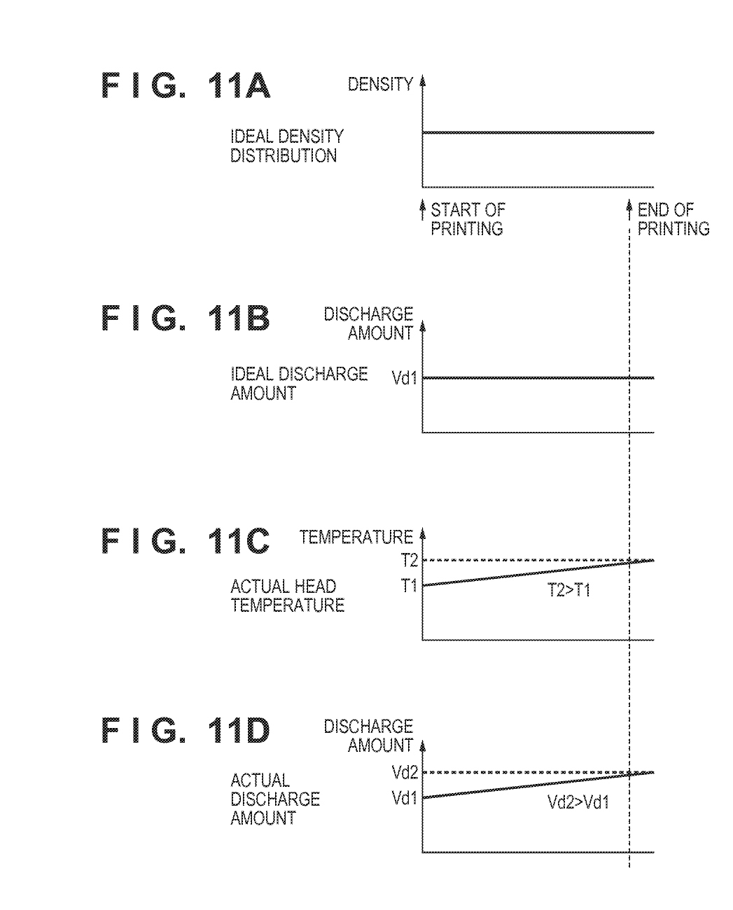

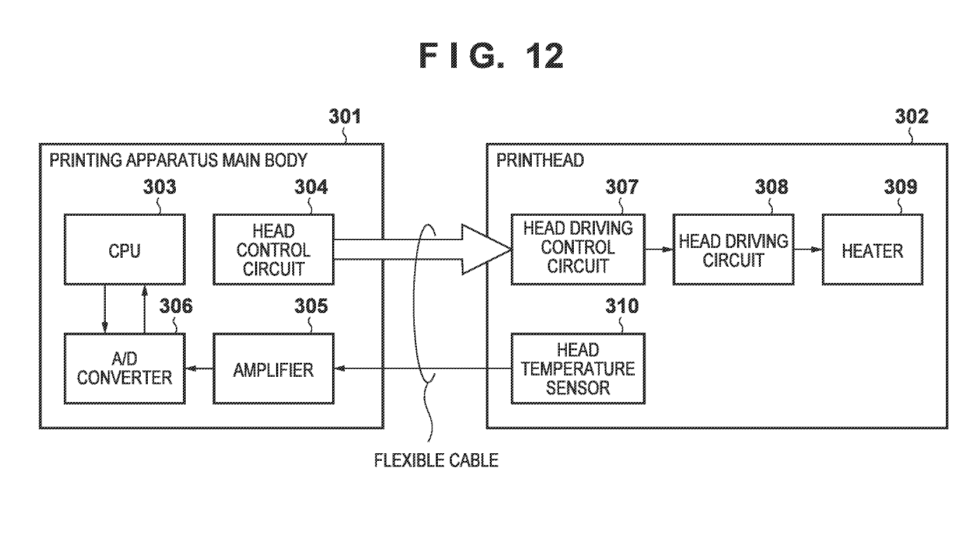

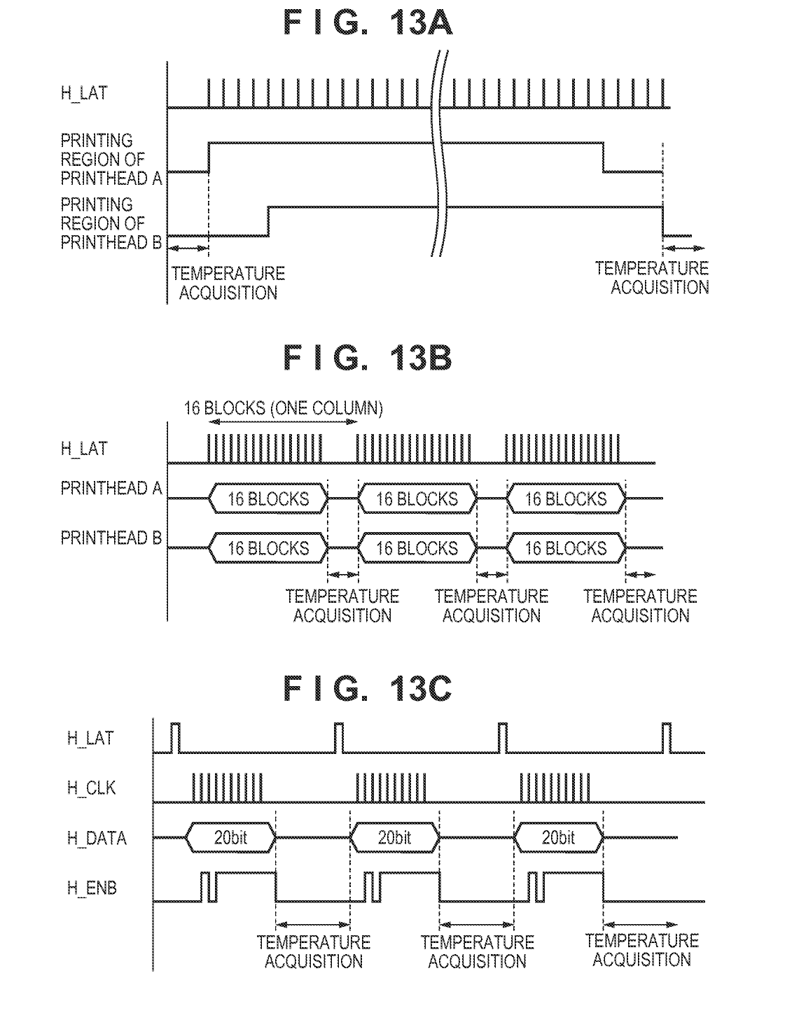

Two methods of obtaining the head temperature in the inactive period will be described next with reference to FIGS. 6 and 7.

According to the first method, A/D conversion is executed by triggering the A/D converter 109 to perform A/D conversion only in an inactive period.

FIG. 6 is a timing chart of signals associated with the first method. Referring to FIG. 6, a signal AD_ENB is asserted in an inactive period. The A/D trigger generation block 209 generates a signal AD_TRG serving as an external trigger signal of A/D conversion in response to the signal AD_ENB. The A/D converter 109 is activated by the signal AD_TRG to execute A/D conversion, and a head temperature data signal AD_OUT and a strobe signal AD_STB after A/D conversion are asserted. The head temperature data signal after A/D conversion is stored in the A/D value storing register 210 in accordance with the signal AD_STB. The CPU 101 reads the value stored in the A/D value storing register 210 in a predetermined period, thereby obtaining precise head temperature data.

An arrangement which generates an interrupt signal so that the CPU 101 reads the value stored in the A/D value storing register 210 may be adopted, as a matter of course.

According to the second method, only a temperature data signal obtained by executing temperature measurement in an inactive period is received while always executing A/D conversion.

FIG. 7 is a timing chart of signals associated with the second method. According to this method, since the A/D converter 109 always executes A/D conversion, a temperature data signal AD_OUT and a strobe signal AD_STB after A/D conversion are output every time A/D conversion is executed, as shown in FIG. 7. The temperature data signal is then stored in the A/D value storing register 210. On the other hand, the A/D trigger generation block 209 activates the DMA controller 211 in response to a signal AD_ENB to DMA-transfer only a temperature data signal obtained by A/D conversion in an inactive period to the temperature acquisition data storage area of the RAM 103. The CPU 101 accesses the temperature acquisition data storage area in a predetermined period, thereby obtaining precise head temperature data.

According to this embodiment, the above-mentioned first and second methods employ an arrangement which performs mode setting by register setting of the head temperature detection unit.

The first and second methods can also be executed in combination, as shown in FIG. 8. In this case, A/D conversion is executed only in an inactive period to DMA-transfer head temperature data stored in the A/D value storing register 210 to the temperature acquisition data storage area of the RAM 103.

According to the above-mentioned embodiment, a temperature data signal from the temperature sensor of the printhead can be input to the printing apparatus main body at the timing at which neither a data signal nor a control signal is transferred to the printhead. Therefore, in a flexible cable which connects the printhead and the printing apparatus main body to each other, no noise derived from crosstalk generated upon signal transfer is mixed with a temperature data signal, thus allowing temperature control with high accuracy.

Also, by dividing one column period into blocks larger in number than division driving blocks by only a small number (two in this embodiment), and setting an operation of inputting a temperature data signal in the period between successive data signal transfer operations for each column, the temperature data signal can be obtained without slowing down the printing speed.

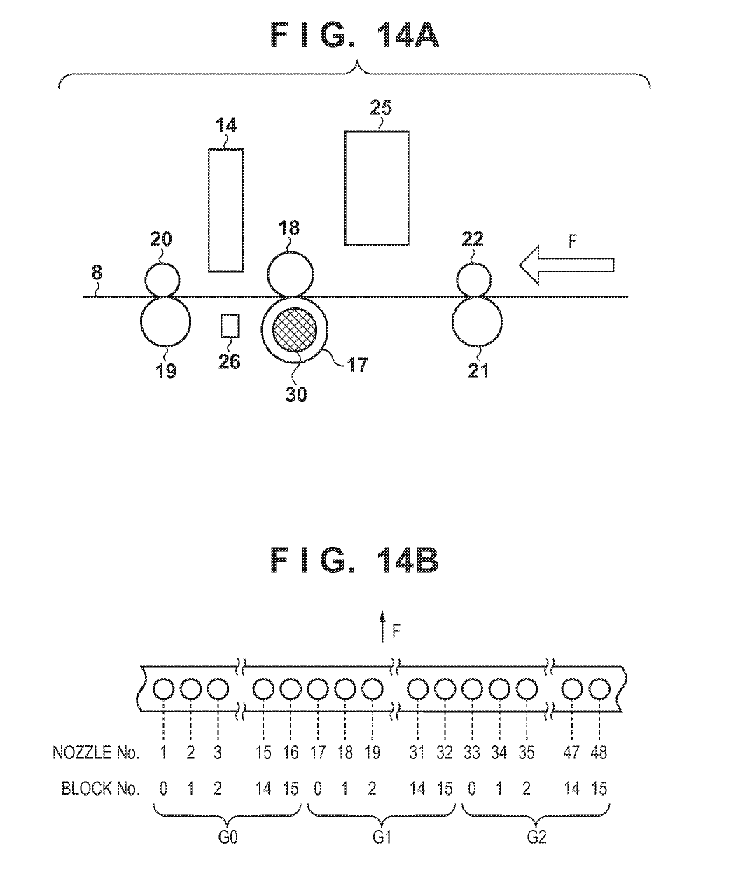

Another embodiment will be described next. FIG. 14A is a sectional view of a full-line inkjet printing apparatus capable of color printing. A main conveyance roller 17 and a main pinch roller 18 are arranged upstream of a printhead 14. In contrast, a sub-conveyance roller 19 and a sub-pinch roller 20 are arranged downstream of the printhead 14. Also, a pre-main conveyance roller 21 and a pre-main pinch roller 22 are arranged upstream of the main conveyance roller 17. These rollers convey a printing medium 8 along the path below the printhead 14 in a direction indicated by an arrow F. A rotary encoder 30 is provided in the main conveyance roller 17, and detects the rotation phase of the main conveyance roller 17. A speed measurement unit 25 is placed between the main conveyance roller 17 and the pre-main conveyance roller 21. A paper leading edge detection sensor 26 is disposed below the printhead 14. The amount of movement of the printing medium 8 per predetermined rotation amount (unit rotation amount) of the main conveyance roller 17 is obtained using the rotary encoder 30.

The full-line inkjet printhead 14 includes nozzles, the number of which corresponds to the width of the printing medium 8, as shown in FIG. 14B. The nozzles are aligned in the direction in which they intersect with the direction F in which the printing medium 8 is conveyed. In this case, the printhead 14 includes 48 nozzles, for the sake of easy explanation. Sixteen adjacent nozzles form one group (G0 to G2), which is divided into 16 blocks and driven. In this configuration as well, the above-mentioned control can be realized.

As a supplement to the description with reference to FIG. 2, in this embodiment, one raster period is equally divided by the sum of the number of driving blocks and the number of blocks corresponding to the time required to obtain the temperature. Also, the motor control unit 106 controls a motor which drives the main conveyance roller 17.

As a supplement to the description with reference to FIG. 3, the above-mentioned serial printing apparatus sets the column position and the column period. On the other hand, the full-line printing apparatus sets the raster position and the raster period. As long as this is taken into consideration, the arrangement shown in FIG. 3 is also applicable to the full-line printing apparatus.

For example, a value which divides one raster period can be set in the division block count register 201. The division block count register 201 is referred to so as to divide one raster period, thereby generating a synchronization signal in the block period. Also, the printing start position and printing end position in the direction in which the printing medium is conveyed are set in the printing region setting register 212. The number of blocks used to drive one raster is set in the driving block count register 203.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-285169, filed Dec. 21, 2010, which is hereby incorporated by reference herein in its entirety.

What is claimed is:

1. A printing apparatus comprising:
a printhead including a plurality of printing elements and a temperature sensor;
a driving unit configured to divide the plurality of printing elements into a plurality of blocks to print on a printing medium and perform division driving of the plurality of printing elements for each block;
an A/D converter configured to A/D-convert an analog temperature data signal output from the temperature sensor;
a division unit configured to divide one printing period of the printhead, which is determined by a driving frequency of the printhead, into an active period required for the division driving, and an inactive period required for A/D conversion by said A/D converter;
a transfer unit configured to transfer a signal required to drive the printhead to the printhead in the active period; and
a reading unit configured to read a digital signal obtained by A/D-converting, by said A/D converter, the temperature data signal output from the printhead in the inactive period.

2. The apparatus according to claim 1, wherein said reading unit triggers said A/D converter to perform A/D conversion in the inactive period.

3. The apparatus according to claim 1, wherein said A/D converter always executes A/D conversion, and
said reading unit reads a temperature data signal obtained by executing temperature measurement by the temperature sensor in the inactive period.

4. The apparatus according to claim 1, further comprising a memory unit configured to store the digital signal obtained by A/D conversion.

5. The apparatus according to claim 1, wherein
said division unit includes:
a setting unit configured to set a number of divisions in the one printing period; and
an assignment unit configured to assign a time period corresponding to the number of times of division driving of the number of divisions to the active period, and assign a time period corresponding to a remaining number of divisions to the inactive period, and
lengths of the periods divided by the number of divisions are equal to each other.

6. The apparatus according to claim 1, wherein
the plurality of printing elements include heaters, respectively, and
the printhead comprises an inkjet printhead which heats ink using said heaters to discharge ink droplets.

7. A temperature detection method for a printing apparatus which includes a printhead including a plurality of printing elements and a temperature sensor, and divides the plurality of printing elements into a plurality of blocks to print on a printing medium while performing division driving of the plurality of printing elements for each block, comprising:
dividing one printing period of the printhead, which is determined by a driving frequency of the printhead, into an active period required for the division driving and an inactive period required for an A/D converter to A/D-convert an analog temperature data signal output from the temperature sensor;
transferring a signal required to drive the printhead to the printhead in the active period; and
reading a digital signal obtained by A/D-converting, by the A/D converter, the temperature data signal output from the printhead in the inactive period.
